(19) United States
(12) Patent Application Publication
(10) Pub. No.: US 2026/0361355 A1
(43) Pub. Date: Nov. 12, 2026

(54) BEAM ALIGNMENT

(71) Applicant: Nokia Solutions and Networks Oy, Espoo (FI)

(72) Inventors: Hao LIU, Shanghai (CN); Tao YANG, Shanghai (CN)

(21) Appl. No.: 19/485,788

(22) PCT Filed: May 21, 2023
(86) PCT No.: PCT/CN2023/095423

§ 371 Date: Nov. 19, 2025

(51) Int. Cl. H04B 7/06; H04B 7/08

(52) U.S. Cl. CPC H04B 7/0617; H04B 7/0682; H04B 7/06962; H04B 7/086

(57) ABSTRACT

Example embodiments of the present disclosure relate to an apparatus, method, and computer readable storage medium for beam alignment. In a method, an apparatus receives, from a further apparatus, a plurality of sets of signals using a plurality of receiving beams via a receiving antenna array. Based on at least the plurality of receiving beams and the plurality of sets of signals, the apparatus determines a plurality of pairs of directions of arrival (DoAs) and directions of departure (DoDs) associated with at least one communication path between the apparatus and the further apparatus. Then, based on the plurality of pairs of DoAs and DoDs, the apparatus determines angle and distance information associated with the at least one communication path. Further, the apparatus causes beamforming to be performed based on the angle and distance information, for communication between the apparatus and the further apparatus.

### FIELDS

Various example embodiments of the present disclosure generally relate to the field of telecommunication and in particular, to an apparatus, method, and computer readable storage medium for beam alignment.

### BACKGROUND

Terahertz (THz) ultra-massive multiple-input multiple-output (UM-MIMO) systems are promising in enabling next-generation wireless communications. Such systems can offer high data rates with a tens of gigahertz (GHz) continuous bandwidth and high spectral efficiency. In the THz UM-MIMO systems, a paradigm of cross-field communications is emerging since THz transmission distances span from near-field to far-field. To achieve the benefits of THz UM-MIMO, precise beam alignment implemented through beam training or beam scanning is required. The precision of the beam alignment may be performed with codebooks associated with angle information as well as distance information. However, existing searching-based approaches with both the angle and distance information introduce relatively higher training overhead.

### SUMMARY

In a first aspect of the present disclosure, there is provided an apparatus. The apparatus comprises at least one processor; and at least one memory storing instructions that, when executed by the at least one processor, cause the apparatus at least to: receive, from a further apparatus, a plurality of sets of signals using a plurality of receiving beams via a receiving antenna array; determine, based on at least the plurality of receiving beams and the plurality of sets of signals, a plurality of pairs of directions of arrival (DoAs) and directions of departure (DoDs) associated with at least one communication path between the apparatus and the further apparatus; determine, based on the plurality of pairs of DoAs and DoDs, angle and distance information associated with the at least one communication path; and cause beamforming to be performed based on the angle and distance information, for communication between the apparatus and the further apparatus.

In a second aspect of the present disclosure, there is provided a method. The method comprises: receiving, from a further apparatus, a plurality of sets of signals using a plurality of receiving beams via a receiving antenna array; determining, based on at least the plurality of receiving beams and the plurality of sets of signals, a plurality of pairs of DoAs and DoDs associated with at least one communication path between the apparatus and the further apparatus; determining, based on the plurality of pairs of DoAs and DoDs, angle and distance information associated with the at least one communication path; and causing beamforming to be performed based on the angle and distance information, for communication between the apparatus and the further apparatus.

In a third aspect of the present disclosure, there is provided an apparatus. The first apparatus comprises means for receiving, from a further apparatus, a plurality of sets of signals using a plurality of receiving beams via a receiving antenna array; means for determining, based on at least the plurality of receiving beams and the plurality of sets of signals, a plurality of pairs of DoAs and DoDs associated with at least one communication path between the apparatus and the further apparatus; means for determining, based on the plurality of pairs of DoAs and DoDs, angle and distance information associated with the at least one communication path; and means for causing beamforming to be performed based on the angle and distance information, for communication between the apparatus and the further apparatus.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example system model according to some example embodiments of the present disclosure;

FIG. 3 illustrates a flowchart of an example method of beam alignment in accordance with some example embodiments of the present disclosure;

FIG. 4A illustrates beam alignment performance with far-field and near-field beams in accordance with some example embodiments of the present disclosure;

FIGS. 4B and 4C illustrate example results of signal-to-noise ratio (SNR) evaluations according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As discussed above, in the THz UM-MIMO systems, a paradigm of cross-field communications is emerging since THz transmission distances span from near-field to far-field. For example, as a boundary between far-field and near-field, a Rayleigh distance of an antenna array is proportional to a square of an array aperture divided by a wavelength. The Rayleigh distance can be calculated as

$$\frac{2 {S}^{2}}{λ} ,$$

where s denotes the array aperture, and λ represents the wavelength. As a result, the Rayleigh distance grows with the rapid increment of an array size, as well as the decrement of a wavelength. Considering a uniform planar array (UPA) with 1024 elements at 0.1 THz with half-wavelength spacing, the Rayleigh distance is calculated as around 3 m. This distance could be further increased to hundreds and even thousands of meters in THz widely-spaced multi-subarray (WSMS) systems, e.g., co-located yet distributed subarrays with large spacing among the subarrays. Therefore, communication distances could range from near-field to far-field in indoor and outdoor scenarios.

To achieve the benefits of THz UM-MIMO, precise beam alignment implemented through beam training or beam scanning is required. The precision of the beam alignment may be performed with codebooks associated with angle information. Based on a traditional far-field planar-wave channel model (PWM), phases of an array response vector possess a linear relationship with spatial angles. Therefore, the beam codebooks related to discrete spatial angles are designed. Considering a near-field spherical-wave channel model (SWM), phases of an array response vector are additionally related to a propagation distance. Accordingly, the codebooks are designed relating to discrete spatial angles as well as distances.

Existing searching-based approaches for beam alignment find a beam direction by testing beam pairs in the pre-defined codebooks, which include near-field exhaustive search and far-field exhaustive search. In the far-field exhaustive search (or training), the beam pairs possess only angle domain resolution. In the near-field exhaustive search, beams pairs with both angle and distance domain resolutions are searched. Compared to the far-field training, the near-field search or training applied in cross-field scenarios can introduce additional distance domain searching which increases the training accuracy but have higher training overhead despite of the codebook design and training strategy. Thus, both the near-field training and the far-field training are not effective to be deployed for THz cross far-field and near-field communications.

Example embodiments of the present disclosure propose a beam alignment scheme. With this scheme, after an apparatus receives signals from a further apparatus by beam swapping, the apparatus determines pairs of directions of arrival (DoAs) and directions of departure (DoDs) associated with the received signals based on at least used receiving (Rx) beams. The DoA and DoD may be represented by an angle of arrival (AoA) and an angle of departure (AoD), respectively. In the context of the present disclosure, the terms “DoA” and “AoA” may be interchangeably used, and the terms “DoD” and “AoD” may also be interchangeably used. Based on the pairs of DoAs and DoDs, the apparatus determines angle and distance information associated with at least one communication path between the apparatus and the further apparatus. Using the angle and distance information, beamforming is performed for communication between the apparatus and the further apparatus.

In this way, a far-field training with estimation (FTE) framework may be used for cross-field or near-field beam alignment. Therefore, precise beam alignment may be achieved with low processing complexity.

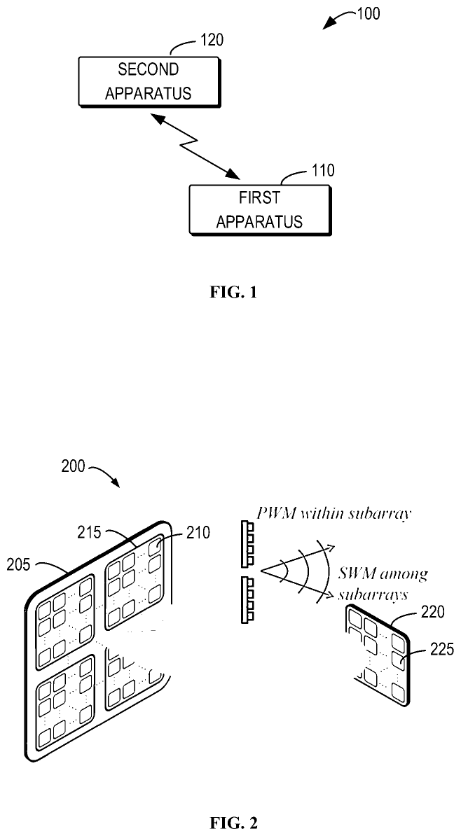

FIG. 1 illustrates an example communication environment 100 in which example embodiments of the present disclosure can be implemented.

The communication environment 100, which may be a part of a communication system, may include a plurality of communication devices, comprising a first apparatus 110 and a second apparatus 120. The first and second apparatuses 110 and 120 can communicate with each other. In some example embodiments, the first apparatus 110 may operate as a network device such as a base station, and the second apparatus 120 may operate as a terminal device such as a UE.

In the following, for the purpose of illustration, some example embodiments are described with the second apparatus 120 operating as a terminal device and the first apparatus 110 operating as a network device. However, in some example embodiments, operations described with respect to a terminal device may be implemented at a network device or other devices, and operations described with respect to a network device may be implemented at a terminal device or other devices.

In some example embodiments, if the first apparatus 110 is a terminal device and the second apparatus 120 is a network device, a link from the second apparatus 120 to the first apparatus 110 is referred to as a DL, while a link from the first apparatus 110 to the second apparatus 120 is referred to as a UL. In DL, the second apparatus 120 is a Tx device (or a transmitter), and the first apparatus 110 is a Rx device (or a receiver). In UL, the first apparatus 110 is a Tx device (or a transmitter), and the second apparatus 120 is a Rx device (or a receiver). If the first apparatus 110 and the second apparatus 120 are both terminal devices, a link between the first apparatus 110 and the second apparatus 120 is referred to as a sidelink (SL). In SL, one of the first apparatus 110 and the second apparatus 120 is a Tx device (or a transmitter), and the other of the first apparatus 110 and the second apparatus 120 is a Rx device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connections are shown in FIG. 1 only for the purpose of illustration without suggesting any limitation. The communication environment 100 may include any suitable number of devices configured to implement example embodiments of the present disclosure.

In the communication environment 100, either or both of the first and second apparatuses 110 and 120 may be provided with a plurality of antenna subarrays/subpanels, each of the antenna subarrays/subpanels having a group of antenna elements that controls a beam independently. In the context of the present disclosure, the terms “antenna subarray” and “antenna subpanel” mean the same and can be used interchangeably. On an antenna subarray/subpanel, a beam can be selected and used for reception. Across different antenna subarrays/subpanels, a plurality of beams (each selected per subarray/subpanel) may be used for reception. A beam may be considered as a mean spatial filter associated with reception. It is to be understood that any number of antenna subarrays can be arranged at the first apparatus 110 and/or the second apparatus 120 depending on the implementations.

In some example embodiments, the first and second apparatuses 110 and 120 may be provided with antenna arrays, and each of the antenna arrays may comprise a plurality of antenna elements. The first and second apparatuses 110 and 120 may perform beam alignment to improve communication quality, especially, in THz cross-field communications. An example beam alignment process will be described below with reference to FIG. 2.

FIG. 2 shows an example system model 200 according to some example embodiments of the present disclosure.

The system model 200 may represent a generalized THz UM-MIMO system. In this example, the first apparatus 110, which may be a BS, is equipped with a planar-shaped UM-MIMO array 205, which contains N_{b} antenna elements 210 that are uniformly divided into K_{b} subarrays 215. Each subarray 215 contains

$${N}_{a b} = \frac{{N}_{b}}{{K}_{b}}$$

antenna elements 210. Within a subarray 215, the antenna spacing

$$d = \frac{λ}{2} ,$$

where λ denotes the carrier wavelength. The subarray spacing can be d or multiple of d. The second apparatus 120, which may be a UE, is equipped with a UPA 220 that contains Nᵤ antenna elements 225, with the same antenna spacing d.

In a beam training process of the first apparatus 110, the received signal y at the first apparatus 110 can be represented as

y=w^{H}Hfs+w^{H}n, (1)
where w=W_{RF}w_{BB}∈C^{N}^{_{b}} refers to a combining vector at the first apparatus 110, W_{RF}∈C^{N}^{_{b}}^{×N}^{_{RF}} denotes an analog combiner, w_{BB} denotes a digital combiner, and N_{RF} represents the number of RF chains. Each subarray 215 is connected to one RF chain, e.g., N_{RF}=K_{b}. Therefore, W_{RF} may have a block diagonal form as below:

W_{RF}=blk diag{w₁, . . . ,w_{K}_{_{b}}}, (2)
where wₖ∈C^{N}^{_{ab}} represents a combining vector of the k^{th} RF-chain, with k=1, . . . , K_{b}. The analog combining may be implemented by phase shifters, and each element in wₖ satisfies the constant modulus constraint as

$$\vert {w}_{k} ( i ) \vert = \frac{1}{\sqrt{{N}_{a b}}} .$$

The digital combiner is w_{BB}∈C^{N}^{_{RF}}. The channel matrix is H∈C^{N}^{_{b}}^{×N}^{ᵤ}.

At the second apparatus 120, a fully-connected (FC) structure with N_{RF} RF-chains is deployed. The beamforming vector f=F_{RF}f_{BB}∈C^{N}^{ᵤ}, where F_{RF}∈C^{N}^{ᵤ}^{×N}^{_{RF}} and f_{BB}∈C^{N}^{_{RF}} denote the analog and digital beamformers, respectively. In the FC structure, each RF chain connects to all antenna elements, and therefore, F_{RF} does not contain zeros as W_{RF}. Each element of F_{RF} satisfies the constant modulus constraint as

$$\vert {F}_{R F} ( i , j ) \vert = \frac{1}{\sqrt{{N}_{u}}} .$$

In addition, to satisfy the power constraint, there is ∥F_{RF}f_{BB}∥²=1 and ∥W_{RF}w_{BB}∥²=1. The pilot signal s satisfies E[s]²=P, where P denotes the transmit power. Moreover, n∈C^{N}^{ᵤ} represents additive white Gaussian noise (AWGN).

In an example, a hybrid spherical-wave and planar-wave channel model (HSPM) is used, which has been demonstrated to achieve a good balance in high modeling accuracy and low complexity. As shown in FIG. 2, at the first apparatus 110, a planar-wave channel model (PWM) is used within a subarray 215, and a spherical-wave channel model (SWM) is used among subarrays 215 between the first apparatus 110 and the second apparatus 120.

The HSPM for the system model 200 can be represented as

$$H = {Σ}_{p} {α}_{p} [ {{a}_{b p}^{1} ( {a}_{u p}^{1} )}^{H} ; … ; {e}^{- j {ΔΦ}_{{K}_{b} p}} {{a}_{b p}^{{K}_{b}} ( {a}_{u p}^{{K}_{b}} )}^{H} ] \qquad ( 3 )$$

where Nₚ denotes the total number of propagation paths. The complex path gain for the p^{th} path is depicted by αₚ, with p=1, . . . , Nₚ.

The array response vectors at a subarray 215 of the first apparatus 110 and at the antenna array 220 of the second apparatus 120 are denoted as

$${a}_{bp}^{k} ∈ {C}^{{N}_{a b}}$$

and

$${a}_{up}^{k} ∈ {C}^{{N}_{u}} ,$$

with subscripts b and u deployed to identify the first apparatus 110 (such as a BS) and the second apparatus 120 (such as a UE), respectively. The array response vector follows a unified form.

In an example, an N element square-shaped UPA on the x-z plane with the physical angle pair (θ,φ) may be used. The array response vector can be expressed as a_{N}(ψₓ,ψ_{z})=a_{\sqrt{N}}(ψₓ)⊗a_{\sqrt{N}}(ψ_{z})∈C^{N}, where the array response vector on one axis is expressed by

$${a}_{\sqrt{N}} ( ψ ) = {[ 1 , … , {e}^{j \frac{2 π}{λ} ( \sqrt{N} - 1 ) ψ} ]}^{T} , \qquad ( 4 )$$

where ψₓ=sin θ cos φ and ψ_{z}=sin θ denote virtual angles on the x-axis and z-axis, respectively. Moreover,

$$Δ {Φ}_{k p} = \frac{2 π}{λ} ( {D}^{{k}_{p}} - {D}_{p} )$$

denotes a phase shift term. For the p^{th} path, D^{k}^{ₚ} and Dₚ represent a distance between the second apparatus 120 and the k^{th} and the first subarrays 215 at the first apparatus 110, respectively.

The HSPM may be arranged into a more compact form as

$$H = {\sum }_{p} {α}_{p} {A}_{bp} {A}_{up}^{H} , where \qquad ( 5 )$$

$${A}_{bp} = blk diag [ {a}_{bp}^{1} , … , {e}^{- j {ΔΦ}_{{K}_{b} p}} {a}_{b p}^{{K}_{b}} ] , {A}_{up} = [ {a}_{bp}^{1} , … , {a}_{b p}^{{K}_{b}} ] .$$

Beam alignment aims at finding the optimal precoder and combiner to maximize the received power or SNR as

{wₒₚₜ,fₒₚₜ}=argmax∥w^{H}Hf∥² (6)

Equation (6) is subject to

$$\vert {w}_{κ} ( i ) \vert = \frac{1}{\sqrt{{N}_{a b}}} , \vert {F}_{R F} ( i , j ) \vert = \frac{1}{\sqrt{{N}_{u}}} \cdot {‖ {F}_{R F} {f}_{B B} ‖}^{2} = 1 , {‖ {W}_{R F} {w}_{B B} ‖}^{2} = 1 .$$

The optimal wₒₚₜ,fₒₚₜ are determined by the path with the strongest power.

A THz channel possesses line-of-sight (LoS) dominant property, and the power of the LoS path is much larger than a sum of powers of other paths. Due to the LoS dominant property of the THz channel, THz beam alignment may align to the LoS path direction. In the case of focusing on the alignment of the LoS path, the subscript p may be eliminated to only denote the LoS path. In this case, wₒₚₜ and fₒₚₜ can be obtained by setting

$${W}_{RF} = \frac{1}{\sqrt{{N}_{ab}}} [ {a}_{b}^{1} , … , 0 ; … ; 0 , … , {e}^{- j {ΔΦ}_{{K}_{b} p}} {a}_{b p}^{{K}_{b}} ] , {F}_{RF} = \frac{1}{\sqrt{{N}_{u}}} [ {α}_{u}^{1} , … , {a}_{u}^{{K}_{b}} ] , {w}_{BB} = {f}_{BB} = \frac{1}{\sqrt{{K}_{b}}} 1.$$

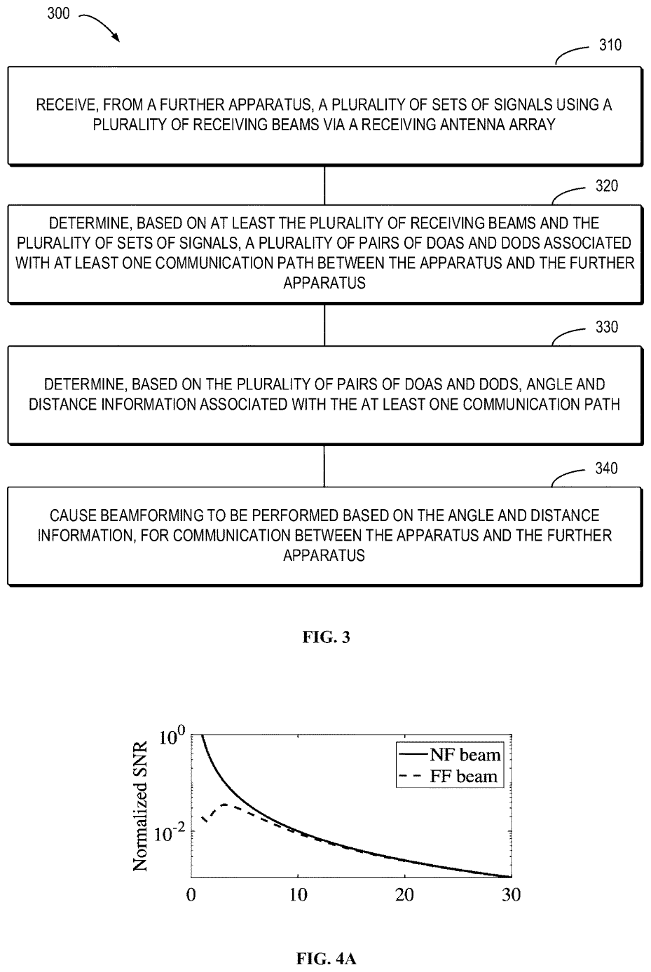

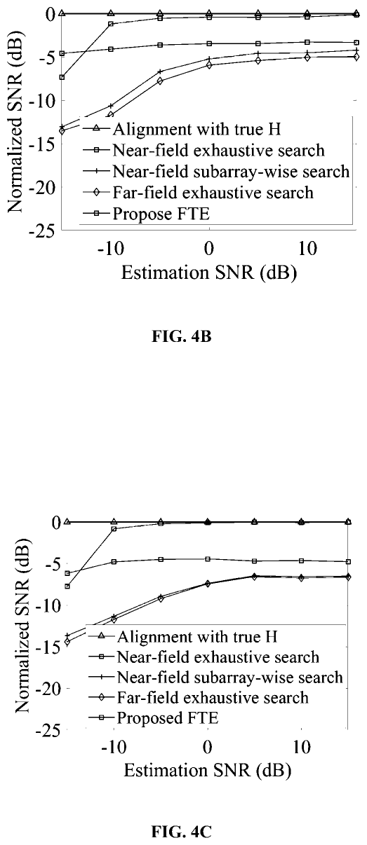

In various example embodiments of the present disclosure, by beam training, angle and distance information associated with at least one communication path (such as the LoS path) is estimated for alignment. As such, the beam alignment may be more accurate while the training overhead may be reduced significantly. Some example implementations will be described below with reference to FIGS. 3, 4A, 4B and 4C.

FIG. 3 shows a flowchart of an example method 300 of beam alignment in accordance with some example embodiments of the present disclosure. The method 300 can be implemented by either the first apparatus 110 or the second apparatus 120 in FIG. 1. For the purpose of discussion, the method 300 will be described from the perspective of the first apparatus 110 with reference to FIG. 1.

As shown in FIG. 3, at block 310, the first apparatus 110 receives, from a further apparatus such as the second apparatus 120, a plurality of sets of signals using a plurality of Rx beams via a Rx antenna array (for example, the antenna array 205 as shown in FIG. 2). For example, in the example embodiments where the receiving antenna array comprises a plurality of antenna subarrays as shown in FIG. 2, the first apparatus 110 may receive the plurality of sets of signals via the plurality of antenna subarrays in the receiving antenna array. In some example embodiments, the transmitter such as the second apparatus 120 may transmit signals using a plurality of Tx beams via a Tx antenna array (for example, the antenna array 220 as shown in FIG. 2).

At block 320, based on at least the plurality of Rx beams and the plurality of sets of signals, the first apparatus 110 determines a plurality of pairs of DoAs and DoDs associated with at least one communication path between the apparatus and the further apparatus. In some example embodiments, the plurality of pairs of DoAs and DoDs may be determined for the LoS path between the first apparatus 110 and the second apparatus 120 to further reduce the training complexity. The DoA and/or DoD may have a plurality of values in a plurality of dimensions, for example, two values in x-axis and z-axis in the case that a UPA with the x-z plane is used.

In some example embodiments, the plurality of pairs of DoAs and DoDs may be determined per antenna subarray of the plurality of antenna subarrays. In an example, the plurality of pairs of DoAs and DoDs may be determined jointly for the plurality of subarrays. In another example, the plurality of pairs of DoAs and DoDs may be determined concurrently for the plurality of subarrays. For example, a pair of a DoA and a DoD may be determined for an antenna subarray based on a set of signals received via the antenna subarray. In this way, the training overhead and the searching complexity may be further reduced, and thus the training efficiency may be improved.

In some example embodiments, the first apparatus 110 may determine a DoA of a pair of a DoA and a DoD based on the plurality of Rx beams and a plurality of predetermined Rx codebooks. In some example embodiments, the DoD of the pair of the DoA and the DoD may be determined based on the plurality of Tx beams and a plurality of predetermined Tx codebooks. The use of Rx and/or Tx codebooks may further improve the precision of the DoA and/or DoD estimation.

In some example embodiments, in the case of the beam alignment based on a LoS path, in a pair of a DoA and a DoD, the DoD is highly related to the DoA, for example, an opposite of the DoA. In this case, the DoD may be determined based on the DoA. For example, after the first apparatus 110 determines the DoA in a pair of a DoA and a DoD based on the plurality of Rx beams and the plurality of predetermined Rx codebooks, the first apparatus 110 may determine the DoD based on the DoA.

At block 330, based on the plurality of pairs of DoAs and DoDs, the first apparatus 110 determines angle and distance information associated the with at least one communication path between the first apparatus 110 and the second apparatus 120. In some example embodiments, the angle and distance information may be determined for the LoS path between the first apparatus 110 and the second apparatus 120 to further reduce the training complexity. The angle and distance information may comprise information related to both angles and distances.

In some example embodiments, to determine the angle and distance information for beam alignment, the first apparatus 110 may determine a first plurality of phase shifts between a reference antenna subarray of the plurality of antenna subarrays (such as the subarrays 210 in FIG. 2) and remaining antenna subarrays of the plurality of antenna subarrays. The first plurality of phase shifts is associated with the angle and distance information. Any one of the plurality of antenna subarrays may be used as the reference antenna subarray. In an example, the first subarray may be used as the reference antenna subarray. In some example embodiments, the first apparatus 110 may use the first plurality of phase shifts directly for beamforming.

An example beam alignment process will be described below. In this example, during the beam training, a far-field two-dimensional (2D) spatial discrete Fourier transform (DFT) codebook may be used for the compact array at the second apparatus 120 (as a transmitter) and each subarray at the first apparatus 110 (as a receiver). The Rx codebooks for the first apparatus 110 is

$$W = \{ {w}_{11} , … , {w}_{1 {N}_{ab}} , … , {w}_{{K}_{b} {N}_{ab}} \} , where {w}_{kn} = {[ {0}_{( k - 1 ) {N}_{a}}^{T} , {[ {Ξ}_{{N}_{ab}} ( : , n ) ]}^{T} , {0}_{( {K}_{b} - k ) {N}_{a}}^{T} ]}^{T} .$$

The 2D DFT matrix

$${Ξ}_{N} = [ {a}_{N} ( - 1 , - 1 ) , … , {a}_{N} ( \frac{2 ( {n}_{x} - 1 )}{{N}_{x}} - 1 , \frac{2 ( {n}_{z} - 1 )}{{N}_{z}} - 1 ) , … , {a}_{N} ( \frac{2 ( {N}_{x} - 1 )}{{N}_{χ}} - 1 , \frac{2 ( {N}_{z} - 1 )}{{N}_{z}} - 1 ) ] ,$$

where Nₓ=N_{z}=\sqrt{N}. The Tx codebook at the second apparatus 120 is [symbol] ={f₁, . . . , f_{N}_{ᵤ}}, with fₙ_{ᵤ}=Ξ_{N}_{ᵤ}(:,nᵤ), nᵤ=1, . . . , Nᵤ. [symbol] and [symbol] contain N_{b} and Nᵤ codewords, respectively.

By varying the beams at both the first and second apparatuses 110 and 120 to transverse all combinations, N_{b}Nᵤ signals are acquired and collected as Y=[Y₁; . . . ; Y_{K}_{_{b}}]∈C^{N}^{ₚ}^{×N}^{ᵤ}, expressed as

Y=W̅^{H}HF̅+N̅, (7)

where the pilot signal s=\sqrt{P}.

The collected signal for one subarray (for example, a subarray 215) is denoted as Yₖ=[\tilde{y}_{(k-1)N}_{_{ab}}_{+1,1}, . . . , \tilde{y}_{(k-1)N}_{_{ab}}_{+1,N}_{ᵤ}; . . . ; \tilde{y}_{kN}_{_{ab}}_{+1,1}, . . . , \tilde{y}_{kN}_{_{ab}}_{+1,N}_{ᵤ}]. Moreover, F̅=[f₁, . . . , f_{N}_{ᵤ}]∈C^{N}^{ᵤ}^{×N}^{ᵤ}, and W̅=[w₁₁, . . . , w_{K}_{_{b}}_{N}_{_{ab}}]∈C^{N}^{_{b}}^{×N}^{_{b}}, N̅=W̅^{H} N∈C^{N}^{_{b}}^{×N}^{ᵤ} denotes the stacked noise, with N∈C^{N}^{_{b}}^{×N}^{ᵤ} denoting the AWGN. The received signals with corresponding beams in [symbol] and [symbol] are depicted by \tilde{y}ₙ_{_{b}}_{,n}_{ᵤ}.

Given the channel observation matrix Y, an aim is to estimate the set of 5 unknown vectors with 4K_{b}+1 parameters (θ_{b}, θᵤ, φ_{b}, φᵤ, D), where

$${θ}_{b} = {[ {θ}_{b}^{1} , … , {θ}_{b}^{{K}_{b}} ]}^{T} , {θ}_{u} = {[ {θ}_{u}^{1} , … , {θ}_{u}^{{K}_{b}} ]}^{T} ,$$

$${ϕ}_{b} = {[ {ϕ}_{b}^{1} , … , {ϕ}_{b}^{{K}_{b}} ]}^{T} , {ϕ}_{u} = {[ {ϕ}_{u}^{1} , … , {ϕ}_{u}^{{K}_{b}} ]}^{T} ,$$

and D is the communication distance between the second apparatus 120 and the reference antenna subarray of the first apparatus 110.

In some example embodiments, a three-phase beam estimator (TPBE) is used to decompose the beam estimation into the estimation of a DoA, a DoD and a communication distance, which are solved one by one. In the case of the THz beam alignment, the LoS path is considered to estimate the DoA, DoD, and distance for the cross-field beam alignment. In the first phrase of DoA estimation, Y can be further arranged as

$$Y = {\overline{W}}^{H} {\sum }_{p = 1}^{{N}_{p}} {A}_{bp} {S}_{up} + \overline{N} , \qquad ( 8 )$$

where

$${S}_{up} = {α}_{p} {A}_{up}^{H} \overline{F} ∈ \text{?}$$

denotes the equivalent transmit signal at the second apparatus 120.

Similarly, Y^{H} can be arranged as

$${Y}^{H} = {\overline{F}}^{H} {\sum }_{p = 1}^{{N}_{p}} {A}_{up} {S}_{bp} + {\overline{N}}^{H} , \qquad ( 9 )$$

where

$${S}_{bp} = {α}_{p} {A}_{bp}^{H} \overline{W} .$$

Since DoA and DoD are contained in A_{bp} and Aᵤₚ, respectively, the estimation of DoA and DoD may be separated.

The DoA estimator may be deployed to maximize the received power based on Y as

$$( \text{?} , \text{?} ) = arg {max}_{{θ}_{b} , {ϕ}_{b}} {‖ {( {\overline{W}}^{H} {A}_{b} )}^{H} Y ‖}^{2} . \qquad ( 10 )$$

Since the LoS path possesses the highest power, searching the spectrum of the LoS path could yield the estimation of θ_{b} and φ_{b}. In this case, 2K_{b} dimensional searching related unknown parameters is needed. To further reduce the searching complexity, the received signals may be decomposed for each subarray and subarray-wise angle estimation may be performed.

For example, Y can be divided into Y=[Y₁; . . . ; Y_{K}_{_{b}}] based on the received signal model in Equation (7), where Yₖ∈C^{N}^{_{ab}}^{×N}^{ᵤ} denotes the channel observation on a subarray k, which can be represented as

$${Y}_{k} = {\overline{W}}_{k}^{H} {\sum }_{p = 1}^{{N}_{p}} {a}_{bp}^{k} {S}_{upk} + {\overline{N}}_{k} , \qquad ( 11 )$$

where

$${\overline{W}}_{k}^{H} = {Ξ}_{{N}_{ab}} ,$$

$${S}_{upk} = {e}^{- j Δ {Φ}_{kp}} {S}_{up} ,$$

$${\overline{N}}_{k} = \overline{N} ( ( k - 1 ) {N}_{ab} + 1 : {kN}_{ab} , : ) .$$

Therefore, the estimation of

$${θ}_{b}^{k}$$

and

$${ϕ}_{b}^{k}$$

can be obtained by solving the following optimization problem

$$( \text{?} , \text{?} ) = arg {max}_{{θ}_{b}^{k} , {ϕ}_{b}^{k}} {‖ {( {\overline{W}}_{k}^{H} {a}_{b}^{k} )}^{H} {Y}_{k} ‖}^{2} . \qquad ( 12 )$$

where

$${\overline{W}}_{k}^{H}$$

represents a Tx beam k, and

$${a}_{b}^{k}$$

represents a codebook K, which are known. Thus, the estimation of

$${θ}_{b}^{k}$$

and

$${ϕ}_{b}^{k}$$

can be obtained.

In an example, a 2D golden section search approach may be utilized to search for the result with low complexity. In some example embodiments, estimation of

$${θ}_{b}^{k}$$

and

$${ϕ}_{b}^{k}$$

for different subarray k can be carried out in parallel for low time complexity.

In the second phase of DoD estimation, in the case that a UPA 220 without a subarray is used as a Tx antenna array as shown in FIG. 2, it may not be feasible to separate

$${a}_{up}^{k}$$

by k as

$${a}_{b}^{k}$$

and separately estimate the DoDs by a subarray as the DoAs in the first phrase. In this case, based on the geometric relationships, there is

$${θ}_{u}^{k} = - {θ}_{b}^{k} and {ϕ}_{u}^{k} = - {ϕ}_{b}^{k}$$

for the LoS path. Therefore, DoDs may be estimated based on this relationship.

In the third phase of distance estimation, after obtaining the angle estimate, the angle and distance information may be directly calculated based on the estimated angles. In an example, the observation matrix on each subarray can be represented as

$${Y}_{k} = {\overline{W}}_{k}^{H} {\sum }_{p = 1}^{{N}_{p}} {α}_{p} {e}^{- j {ΔΦ}_{kp}} {a}_{bp}^{k} {A}_{up}^{H} \overline{F} + {\overline{N}}_{k} . \qquad ( 13 )$$

To obtain e^{-jΔΦ}^{ₖₚ} that contains the distance information, the following result may be calculated:

$${( {\overline{W}}_{k}^{H} \text{?} )}^{H} {{Y}_{k} ( \text{?} \overline{F} )}^{H} \approx α {e}^{- j {ΔΦ}_{k}} , \qquad ( 14 )$$

where [symbol] and [symbol] represent the constructed array response vector and matrix based on the estimated angles. Therefore, an estimated phase shift vector Φ≈α[e^{-jΔΦ}^{₁}, . . . , e^{-jΔΦ}^{_{K}}_{b}]^{T}. The estimated phase shift vector Φ may be used for beamforming.

In order to mitigate deviations of the estimated angle and distance information due to the existence of accumulation errors, especially at a low SNR, in some example embodiments, the first apparatus 110 may use a plurality of ranges of DoAs and DoDs from the plurality of pairs of DoAs and DoDs as well as a range of communication distances between the first apparatus 110 and the second apparatus 120 to refine the estimate of the angle and distance information. A range of DoAs or DoDs is determined from a DoA or a DoD. The range of communication distances may be priori information, which may be obtained by the first apparatus 110 in any suitable way. The scope of the present disclosure will not be limited in this regard.

In some example embodiments, based on the plurality of ranges of DoAs and DoDs and the range of communication distances, the first apparatus 110 may determine a second plurality of phase shifts between the reference antenna subarray and the remaining antenna subarrays. Then, based on correlation of the first plurality of phase shifts and the second plurality of phase shifts, the first apparatus 110 may determine a third plurality of phase shifts. The beamforming may be performed based on the third plurality of phase shifts.

In an example, to mitigate the estimation divergence related to the angle and distance information due to the estimation error of the angle, a robust distance estimation algorithm based on the estimation results of

$${θ}_{b}^{k} , {ϕ}_{b}^{k} , {θ}_{u}^{k} and {ϕ}_{u}^{k}$$

is used to further optimize the directly calculated value of distance information D. The distance estimation sub-problem is represented as

$$\hat{D} = arg {max}_{D} {\vert {Φ}^{H} {Φ}_{D , \text{?} \text{?}} \vert}^{2} , \qquad ( 15 )$$

where Φ denotes the phase shift vector calculated in Equation (14). Φ_{D,} [symbol] _{,} [symbol] denotes the phase shift vector constructed based on the estimated angles [symbol] , [symbol] . For example, each element in Φ_{D,} [symbol] _{,} [symbol] is constructed based on

$${ΔΦ}_{k} = \frac{2 π D}{λ} ( \sqrt{1 + \frac{2 ( {Γ}_{kz} {ϖ}_{z} - {Γ}_{kx} {ϖ}_{x} )}{D} + \frac{{Γ}_{kx}^{2} + {Γ}_{kz}^{2}}{{D}^{2}}} - 1 ) , \qquad ( 16 )$$

Equation (16) is calculated based on geometric relationships. Γₖₓ and Γ_{kz} denote the distances of subarray k on the x-axis and z-axis to the first subarray (used as the reference subarray), respectively. The virtual spatial angles ω̅ₓ=sin θ cos φ, ω̅₂=sin φ, θ, φ represent the selected angles, and D represents the selected distance from the range of the communication distances. By taking different values of θ, φ and D, a spectrum |Φ^{H}Φ_{D,} [symbol] _{,} [symbol] |² as in Equation (15) is constructed, the corresponding distance value in the peak of the spectrum denotes the estimated distance.

Since the estimated values of the angles [symbol] , [symbol] have been obtained, it is possible to set θ= [symbol] (1) and φ= [symbol] (1), and directly search the spectrum with different D for distance estimation. However, due to the existence of accumulation errors, directly solving for D with [symbol] , [symbol] could introduce deviations of the estimated distance, especially at low SNR. Therefore, during the search process, neighboring multiple values (e.g., 10) in [symbol] , [symbol] are considered as the selected angle values, and multiple predefined distance values D are used to construct multiple spectrum values. Finally, beam alignment can be achieved based on the estimation result of angles and distances. Compared to existing far-field training approaches, the distance information may be considered in addition to angle information, thereby improving the accuracy of the beam alignment.

At block 340, the first apparatus 110 causes beamforming to be performed based on the angle and distance information, for communication between the first apparatus 110 and the second apparatus 120. In some example embodiments, the beamforming may be performed based on the angle and distance information and the plurality of DoAs and DoDs determined at block 320. In some example embodiments, the beamforming may be performed based on the angle and distance information and the plurality of DoAs and DoDs that is refined based on the ranges of DoAs and DoDs and the range of communication distances as discussed above. As such, beam alignment can be achieved based on the estimation result of angles and distances, which is more accurate and efficient.

In some example embodiments, the plurality of pairs of DoAs and DoDs without distance information may be used for beamforming for a control signal. Based on such beamforming, the received SNR may be sufficient for detection of a control signal in the cross-field. The limited propagation distances in the near-field and the high array gain in the far-field may contribute to this outcome.

In an example, one target of beam training is to deploy narrow beams to enhance the SNR in the initial access for successful control signal reception. By considering the LoS with free-space path loss and noise power σ², the SNR is

$$\frac{P {λ}^{2} {G}_{u} {G}_{b}}{{( 4 πσ D )}^{2}} ,$$

which is positively related to array gains Gᵤ and Gₚ at the transmitter such as the second apparatus 120 and the receiver such as the first apparatus while being negatively proportional to D². The far-field (FF) beam may not be accurate enough and may not provide the highest array gain at short distances, which causes an SNR degradation compared to the near-field (NF) beam. A far-field beam may be used in the short range for training, rather than data transmission. This is reasonable since, over a short distance, the received signal strength, even from the worse-performance far-field beam is still acceptable compared to the far-field case, as illustrated in FIG. 4A where a planar-shaped WSMS with 1,024 antenna elements and 16 subarrays is deployed at the first apparatus 110, the subarray spacing is 128λ, and the second apparatus 120 is equipped with one antenna.

Although directly employing far-field beams enables sufficient SNR for signal detection, some SNR losses still exist compared to using near-field beams in the short range, due to beam misalignment. For example, the far-field beams cannot align to different communication distances. To address this issue, the estimation result of the distance may be additionally used by the first and second apparatuses 110 and 120 to generate directional beams to achieve beam alignment in the cross-field scenarios.

Extensive simulations and performance evaluations show that the proposed beam alignment scheme may improve the precision and reduce the overhead. The beam alignment aims at finding the optimal beams to maximize the received power or SNR. Therefore, the average SNR of the proposed FTE is evaluated and compared to that of different algorithms. In the simulations and evaluations, the system model is employed as shown in FIG. 2, with the central frequency 0.3 THz. The first apparatus 110, which may operate as a BS, is equipped with the THz widely-spaced multiple-subarray (WSMS) UM-MIMO system with N_{RF}=K_{b}=16 RF chains and subarrays, each subarray containing N_{ab}=64 antennas. The subarray spacing is fixed at 128λ. The FC structure at the second apparatus 120, which may operate as a UE, contains Nᵤ=64 antennas and N_{RF}=16 subarrays to fully align with the second apparatus 120. In terms of a channel model, the HSPM is considered, where the number of propagation paths is varied during the evaluation. The path gains αₚ are generated based on a THz channel model. Moreover, the azimuth and elevation angles are randomly generated, following uniform distributions over [−90°,90°). The communication distances for different paths are randomly generated, following a uniform distribution between 3 and 50 m.

To evaluate the SNR performance, the proposed FTE is compared with 4 benchmarks, for example, alignment with true H (serving as an upper bound), near-field exhaustive search, near-field subarray-wise search, and far-field exhaustive search, respectively. The considered benchmarks are introduced in the beam training at the first apparatus 110. In the near-field exhaustive search, similar to existing near-field beam training approaches, both the angle domain with N_{b} grids and distance domain with C_{d} grids are searched. By contrast, in the near-field subarray-wise search, the angle searching is first conducted subarray by subarray at the first apparatus 110 to identify the angle direction for each subarray, and each subarray incorporates N_{ab} grids. After that, the distance domain with C_{d} grids is searched by fixing the angle directions of each subarray. Moreover, the far-field exhaustive search searches only in the angle domain that contains N_{b} angular grids. All the results are obtained with 5000 trials of Monte Carlo simulations.

FIGS. 4B and 4C show example results of SNR evaluations according to some example embodiments of the present disclosure.

In this example, the average normalized SNR by different beam alignment algorithms is compared. In the evaluation, Nₚ=8, and the number of distance grids is selected as C_{d}=30. The WSMS and traditional compact system with an array-of-subarray structure are considered, which is a case of the WSMS with all antennas possessing half-wavelength spacing. As shown in FIG. 4B, the proposed FTE attains near-optimal SNR at estimation SNR>−5 dB, which is only 0.2 dB lower than the upper bound at 0 dB estimation SNR. Thus, the high-precision beam estimation is provided by the TPBE. In comparison, the average SNRs of the searching-based approaches are significantly limited by the searching grid resolution, resulting in SNRs that are 3 dB, 4.3 dB, and 4.8 dB lower than that of the FTE at 10 dB estimation SNR, for the near-field exhaustive search, near-field subarray-wise search, and far-field exhaustive search, respectively. The efficiency of the FTE framework is observed in the compact systems shown in FIG. 4C, which achieves 4.6 dB higher SNR than that of the near-field exhaustive search at 10 dB estimation SNR.

The training overheads of different approaches are summarized in Table 1. With C_{d}=30, as shown in Table 1, the proposed FTE possesses significantly lower training overhead, which possesses only 3.3% of the near-field exhaustive search.

TABLE 1

| Method | Training overhead |
|---|---|
| Near-field exhaustive search | N_{b}NᵤC_{d} |
| Near-field subarray-wise search | N_{b}Nᵤ + C_{d} |
| Far-field exhaustive search | N_{b}Nᵤ |
| Proposed FTE | N_{b}Nᵤ |

The results show that the proposed FTE framework may achieve precise beam alignment. Moreover, compared to the near-field exhaustive search, the FTE greatly reduces training overhead by 96.7% and thus possesses low processing complexity.

### Example Apparatus, Device and Medium

In some example embodiments, an apparatus capable of performing the method 300 (for example, the first apparatus 110 in FIG. 1) may comprise means for performing the respective operations of the method 300. The means may be implemented in any suitable form. For example, the means may be implemented in a circuitry or software module. The apparatus may be implemented as or included in the first apparatus 110 in FIG. 1.

In some example embodiments, the apparatus comprises means for receiving, from a further apparatus, a plurality of sets of signals using a plurality of receiving beams via a receiving antenna array; means for determining, based on at least the plurality of receiving beams and the plurality of sets of signals, a plurality of pairs of directions of arrival (DoAs) and directions of departure (DoDs) associated with at least one communication path between the apparatus and the further apparatus; means for determining, based on the plurality of pairs of DoAs and DoDs, angle and distance information associated with the at least one communication path s; and means for causing beamforming to be performed based on the angle and distance information, for communication between the apparatus and the further apparatus.

In some example embodiments, the means for receiving the plurality of sets of signals comprises: means for receiving the plurality of sets of signals via a plurality of antenna subarrays in the receiving antenna array, wherein a pair of a DoA and a DoD of the plurality of pairs of DoAs and DoDs is determined for an antenna subarray of the plurality of antenna subarrays.

In some example embodiments, the means for receiving the plurality of sets of signals comprises: means for receiving a set of signals of the plurality of sets of signals via the antenna subarray. The means for determining the plurality of pairs of DoAs and DoDs comprises: means for determining, for the antenna subarray, the pair of the DoA and the DoD based on the set of signals.

In some example embodiments, the means for determining the plurality of pairs of DoAs and DoDs comprises: means for determining, for the antenna subarray, at least the DoA of the pair of the DoA and the DoD based on at least the plurality of receiving beams and a plurality of predetermined receiving codebooks.

In some example embodiments, the means for determining at least the DoA of the pair of the DoA and the DoD comprises: means for determining the DoA based on the plurality of receiving beams and the plurality of predetermined receiving codebooks; and means for determining the DoD based on the DoA.

In some example embodiments, the means for determining the angle and distance information comprises: means for determining, based on the plurality of pairs of DoAs and DoDs, a first plurality of phase shifts between a reference antenna subarray of the plurality of antenna subarrays and remaining antenna subarrays of the plurality of antenna subarrays, the first plurality of phase shifts being associated with the angle and distance information.

In some example embodiments, the means for causing beamforming to be performed comprises means for causing beamforming to be performed based on the first plurality of phase shifts.

In some example embodiments, the means for determining the angle and distance information further comprises: means for determining a plurality of ranges of DoAs and DoDs based on the plurality of pairs of DoAs and DoDs, wherein a range of DoAs or DoDs of the plurality of ranges of DoAs and DoDs is determined from a DoA or a DoD of the plurality of pairs of DoAs and DoDs; means for determining a second plurality of phase shifts between the reference antenna subarray and the remaining antenna subarrays based on the plurality of ranges of DoAs and DoDs and a range of communication distances between the apparatus and the further apparatus; means for determining a third plurality of phase shifts between the reference antenna subarray and the remaining antenna subarrays based on correlation of the first plurality of phase shifts and the second plurality of phase shifts. The means for causing beamforming to be performed comprises means for causing beamforming to be performed based on the third plurality of phase shifts.

In some example embodiments, at least one of a DoA or a DoD of the plurality of pairs of DoAs and DoDs has a plurality of values in a plurality of dimensions.

In some example embodiments, the apparatus further comprises means for performing other operations in some example embodiments of the method 300 or the first apparatus 110. In some example embodiments, the means comprises at least one processor; and at least one memory storing instructions that, when executed by the at least one processor, cause the performance of the apparatus.

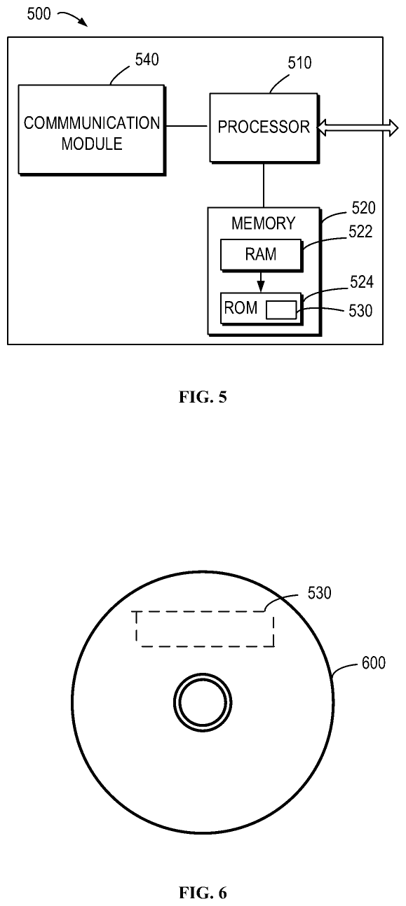

FIG. 5 is a simplified block diagram of a device 500 that is suitable for implementing example embodiments of the present disclosure. The device 500 may be provided to implement a communication device, for example, the first apparatus 110 or the second apparatus 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 1 to FIG. 4C. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, from a further apparatus, a plurality of sets of signals using a plurality of receiving beams via a receiving antenna array;
determine, based on at least the plurality of receiving beams and the plurality of sets of signals, a plurality of pairs of directions of arrival (DoAs) and directions of departure (DoDs) associated with at least one communication path between the apparatus and the further apparatus;
determine, based on the plurality of pairs of DoAs and DoDs, angle and distance information associated with the at least one communication path; and
cause beamforming to be performed based on the angle and distance information, for communication between the apparatus and the further apparatus.

2. The apparatus of claim 1, wherein the at least one memory and the at least one processor cause the apparatus to:
receive the plurality of sets of signals via a plurality of antenna subarrays in the receiving antenna array,
wherein a pair of a DoA and a DoD of the plurality of pairs of DoAs and DoDs is determined for an antenna subarray of the plurality of antenna subarrays.

3. The apparatus of claim 2, wherein the at least one memory and the at least one processor cause the apparatus to:
receive a set of signals of the plurality of sets of signals via the antenna subarray; and
determine, for the antenna subarray, the pair of the DoA and the DoD based on the set of signals.

4. The apparatus of claim 3, wherein the at least one memory and the at least one processor cause the apparatus to, for the antenna subarray,
determine at least the DoA of the pair of the DoA and the DoD based on at least the plurality of receiving beams and a plurality of predetermined receiving codebooks.

5. The apparatus of claim 4, wherein the at least one memory and the at least one processor cause the apparatus to:
determine the DoA based on the plurality of receiving beams and the plurality of predetermined receiving codebooks; and
determine the DoD based on the DoA.

6. The apparatus of claim 2, wherein the at least one memory and the at least one processor cause the apparatus to:
determine, based on the plurality of pairs of DoAs and DoDs, a first plurality of phase shifts between a reference antenna subarray of the plurality of antenna subarrays and remaining antenna subarrays of the plurality of antenna subarrays, the first plurality of phase shifts being associated with the angle and distance information.

7. The apparatus of claim 6, wherein the at least one memory and the at least one processor cause the apparatus to: cause beamforming to be performed based on the first plurality of phase shifts.

8. The apparatus of claim 6, wherein the at least one memory and the at least one processor cause the apparatus to:
determine a plurality of ranges of DoAs and DoDs based on the plurality of pairs of DoAs and DoDs, wherein a range of DoAs or DoDs of the plurality of ranges of DoAs and DoDs is determined from a DoA or a DoD of the plurality of pairs of DoAs and DoDs;
determine a second plurality of phase shifts between the reference antenna subarray and the remaining antenna subarrays based on the plurality of ranges of DoAs and DoDs and a range of communication distances between the reference antenna subarray of the apparatus and the further apparatus;
determine a third plurality of phase shifts between the reference antenna subarray and the remaining antenna subarrays based on correlation of the first plurality of phase shifts and the second plurality of phase shifts; and
cause beamforming to be performed based on the third plurality of phase shifts.

9. The apparatus of claim 1, wherein at least one of a DoA or a DoD of the plurality of pairs of DoAs and DoDs has a plurality of values in a plurality of dimensions.

10. A method comprising:
receiving, from a further apparatus, a plurality of sets of signals using a plurality of receiving beams via a receiving antenna array;
determining, based on at least the plurality of receiving beams and the plurality of sets of signals, a plurality of pairs of directions of arrival (DoAs) and directions of departure (DoDs) associated with at least one communication path between the apparatus and the further apparatus;
determining, based on the plurality of pairs of DoAs and DoDs, angle and distance information associated with the at least one communication path; and
causing beamforming to be performed based on the angle and distance information, for communication between the apparatus and the further apparatus.

11. The method of claim 10, wherein receiving the plurality of sets of signals comprises:
receiving the plurality of sets of signals via a plurality of antenna subarrays in the receiving antenna array,
wherein a pair of a DoA and a DoD of the plurality of pairs of DoAs and DoDs is determined for an antenna subarray of the plurality of antenna subarrays.

12. The method of claim 11, wherein receiving the plurality of sets of signals comprises:
receiving a set of signals of the plurality of sets of signals via the antenna subarray; and
determining the plurality of pairs of DoAs and DoDs comprises:
determining, for the antenna subarray, the pair of the DoA and the DoD based on the set of signals.

13. The method of claim 12, wherein determining the pair of the DoA and the DoD comprises, for the antenna subarray,
determining at least the DoA of the pair of the DoA and the DoD based on at least the plurality of receiving beams and a plurality of predetermined receiving codebooks.

14. The method of claim 13, wherein determining at least the DoA of the pair of the DoA and the DoD comprises:
determining the DoA based on the plurality of receiving beams and the plurality of predetermined receiving codebooks; and
determining the DoD based on the DoA.

15. The method of claim 11, wherein determining the angle and distance information comprises:
determining, based on the plurality of pairs of DoAs and DoDs, a first plurality of phase shifts between a reference antenna subarray of the plurality of antenna subarrays and remaining antenna subarrays of the plurality of antenna subarrays, the first plurality of phase shifts being associated with the angle and distance information.

16. The method of claim 15, wherein causing beamforming to be performed comprises:
causing beamforming to be performed based on the first plurality of phase shifts.

17. The method of claim 15, wherein determining the angle and distance information further comprises:
determining a plurality of ranges of DoAs and DoDs based on the plurality of pairs of DoAs and DoDs, wherein a range of DoAs or DoDs of the plurality of ranges of DoAs and DoDs is determined from a DoA or a DoD of the plurality of pairs of DoAs and DoDs;
determining a second plurality of phase shifts between the reference antenna subarray and the remaining antenna subarrays based on the plurality of ranges of DoAs and DoDs and a range of communication distances between the reference antenna subarray of the apparatus and the further apparatus; and
determining a third plurality of phase shifts between the reference antenna subarray and the remaining antenna subarrays based on correlation of the first plurality of phase shifts and the second plurality of phase shifts; and
causing beamforming to be performed comprises: causing beamforming to be performed based on the third plurality of phase shifts.

18. The method of claim 10, wherein at least one of a DoA or a DoD of the plurality of pairs of DoAs and DoDs has a plurality of values in a plurality of dimensions.

19. (canceled)

20. A computer readable medium comprising instructions stored thereon for causing an apparatus at least to perform the method of claim 10.
